(19) United States
(12) Patent Application Publication
(10) Pub. No.: US 2004/0107992 A1
(43) Pub. Date: Jun. 10, 2004

(54) Air release valve

(76) Inventor: Kevin Richards, Kempton Park (ZA)

Correspondence Address: Michael L Kenaga, Piper Rudnick, P O Box 64807, Chicago, IL, 60664-0807, US

(21) Appl. No.: 10/399,058

(22) PCT Filed: Oct. 10, 2001
(86) PCT No.: PCT/IB01/01887

(30) Foreign Application Priority Data
Oct. 11, 2000 (ZA) 2000/5583

(51) Int. Cl. F16K 24/04

(52) U.S. Cl. 137/202

(57) ABSTRACT

The invention relates to an air release valve (10) which has a valve chamber (12) having an inlet (22) that is connected in use to a liquid pipeline or container. There is a first outlet (26) for venting relatively large volumes of air from the pipeline or container during filling, and a second outlet (64) for venting relatively small volumes of air which accumulate in the chamber during pressurised operation. The first outlet is closed by a float arrangement when liquid rises in the chamber above a predetermined level. A conduit (54) extends to the second outlet from an entrance located in the chamber substantially below this predetermined level. The result is such that a volume of air can accumulate in the chamber to serve as a shock absorber for the pipeline or container before there is a sufficient accumulation to displace liquid from the chamber to a level beneath the entrance. At this stage venting of accumulated air can take place through the conduit and second outlet.

### BACKGROUND TO THE INVENTION

THIS invention relates to an air release valve.

Air release valves are usually installed in pressurised liquid reticulation pipelines to vent to atmosphere gases, usually air, which are entrained with the liquid conveyed in the pipeline.

Known air release valves have a relatively large outlet which allows relatively large volumes of gas to escape during filling of the pipeline with liquid. When the pipeline is full, a closure member closes the outlet and thereafter smaller volumes of air which accumulate in the valve chamber during pressurised operation can escape through a relatively small bleed orifice, typically controlled by a float.

There is also a requirement in some pressurised pipelines for shock absorbing means which can damp hydraulic pressure spikes transmitted through the liquid in the event of, say, pump start-up. Damping is frequently by gas accumulator type dampers in the pipeline.

It is an objective of this invention to provide an air release valve which also serves an hydraulic damping function.

### SUMMARY OF THE INVENTION

According to this invention there is provided an air release valve comprising a valve chamber having an inlet connectable to a liquid pipeline or container, a first outlet for venting relatively large volumes of air from the pipeline or container during filling of the pipeline or container with liquid, a second outlet for venting from the chamber relatively small volumes of air which accumulate in the chamber during pressurised operation of the pipeline or container, means for closing the first outlet when liquid rises in the chamber above a predetermined level, and a conduit which extends to the second outlet from an entrance located in the chamber substantially below the predetermined level, such that a volume of air can accumulate in the chamber to serve as a shock absorber for the pipeline or container before there is a sufficient accumulation of air to displace liquid from the chamber to a level beneath the entrance, whereupon venting of accumulated air can take place through the conduit and second outlet.

In a preferred embodiment, the level of the entrance in the chamber is adjustable. The conduit may for instance be provided by a length of pipe extending downwardly into the chamber from the second outlet, the lower end of the pipe serving as the entrance and the level of that lower end being adjustable. In one version of the invention, the pipe is externally threaded and passes in threaded fashion through a top of the chamber, allowing for the pipe to be screwed further into or out of the chamber.

The preferred air release valve includes:

a dynamic closure which is adapted to seat on the first outlet when sufficiently rapid venting of air takes place from the pipeline during filling thereof, the dynamic closure having a passage extending therethrough which is smaller than the first outlet through which air can vent at a reduced rate, and

a main closure adapted to be buoyed up by liquid in the chamber, when the liquid rises above the predetermined level, to seat on the dynamic closure and close the passage therein, thereby to close the first outlet completely.

### BRIEF DESCRIPTION OF THE DRAWINGS

The invention will now be described in more detail, by way of example only, with reference to the accompanying drawings in which:

FIG. 1 shows a side view, partly in section, of an air release valve according to this invention;

FIG. 2 shows a cross-section at the line 2-2 in FIG. 1; and

FIGS. 3 to 6 diagrammatically illustrate different stages in the operation of the valve of FIGS. 1 and 2.

### DESCRIPTION OF A PREFERRED EMBODIMENT

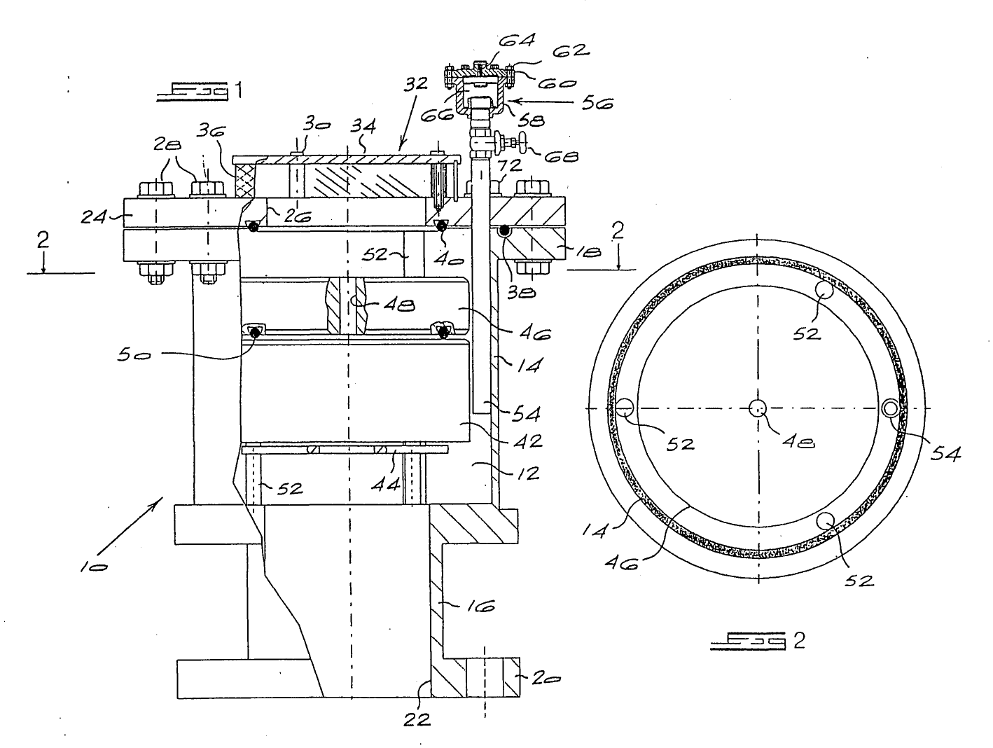

The air release valve 10 seen in FIG. 1 has a valve chamber 12 formed by cylindrical side walls 14 and 16 carrying upper and lower flanges 18 and 20 respectively. The flange 20 surrounds an inlet 22 and in use is connected to a mating flange, typically at a high point in a liquid pipeline (not shown) which conveys liquid under pressure. A lid 24 defining a central, first outlet 26 is connected to the flange 18 by bolts 28. Fastened to the lid by bolts 30 is a structure 32 which has a top wall 34 and a perforated side wall 36 and which is located over the first outlet 26 to prevent dirt and other foreign matter from entering the valve chamber through the outlet. The lid is sealed with respect to the flange 18 by an O-ring 38 and itself carries an O-ring 40 surrounding the outlet 26.

Located in the valve chamber 12 is a cylindrical float 42 which, prior to filling of the pipeline, rests at a low position on a support 44. Located above the float 42 within the chamber 12 is a dynamic closure 46 formed centrally with an air vent passage 48 and carrying an O-ring 50 on its underside around the air vent passage. The air vent passage is of considerably smaller diameter than the first outlet 26.

Vertical movement of the float 42 and dynamic closure 46 within the valve chamber 12, as described below, is guided by three equispaced guides 52 located close to the side wall 14. The support 44 spans between the guides as illustrated. Also located close to the side wall 14, between two adjacent guides 52, is a conduit in the form of a vertical pipe 54. The pipe 54 extends upwardly through the lid 24 to a bleed valve chamber 56 formed by a bottom and sidewall structure 58 and a lid 60 held in place by bolts 62. The lid 60 is pierced by a narrow, central bleed tube or nozzle 64 the lower end of which extends below the underside of the lid 60. A cylindrical float 66 is located in the bleed valve chamber 56 as illustrated. A manually operable gate valve 68 is located in the pipe 54 above the lid 24.

Different stages in the operation of the valve described above will now be described.

Pipeline Filling

When the pipeline is initially filled with liquid, the valve 20 rapidly vents large volumes of air displaced from the pipeline through the large first outlet 26. This is illustrated in FIG. 3 in which the arrows indicate the air flow path through the valve.

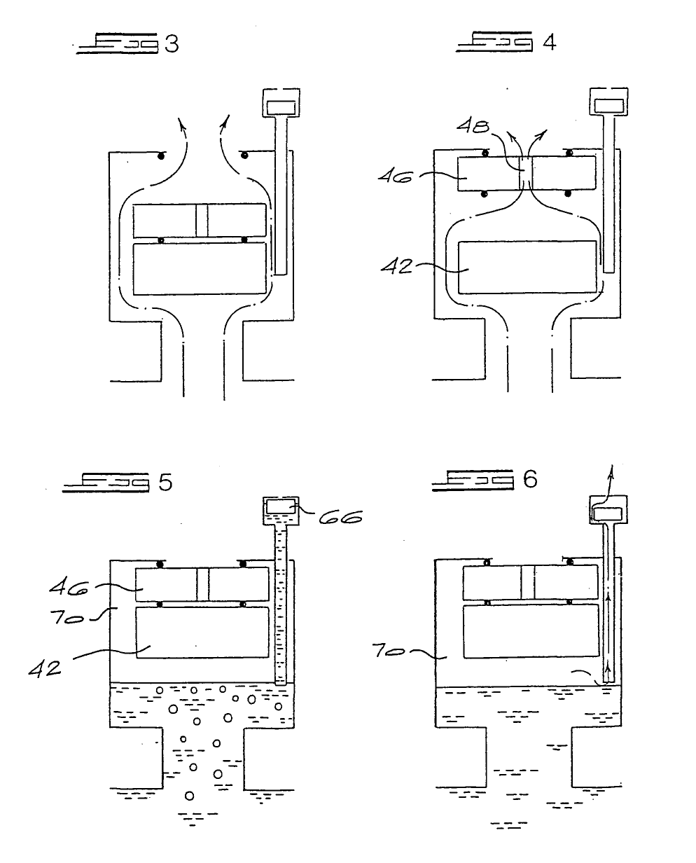

It is generally undesirable for liquid to fill the pipeline too rapidly since this could lead to shock loading of downstream equipment. If the rate at which air is vented from the pipeline should exceed a critical value, the dynamic air pressure differential acting on the dynamic closure 46 lifts the closure up and seats it against the O-ring. 40 as shown in FIG. 4. This effectively reduces the area of the outlet 26 to that of the air vent passage 48 with the result that there is a reduction in the rate at which air can be vented from the pipeline and accordingly at which liquid can fill the pipeline.

The pressure differential acting on the dynamic closure maintains it in its elevated position.

Normal Pressurised Operation

As the pipeline empties of air, liquid enters the valve chamber 12. When the level reaches a predetermined level, the float 42 is buoyed up to seat against the O-ring 50, thereby effectively sealing the outlet 26 as shown in FIG. 5. Liquid now flows under pressure in the normal way through the pipeline with the valve chamber 12 at the operating pressure. The differential pressure force acting on the float and dynamic closure, which together constitute a closure for the first outlet 26, maintains them in their elevated position closing the outlet 26. Air entrained in the liquid flow in the pipeline finds its way into the valve chamber 12 through the inlet 22, and bubbles up into the upper part of the valve chamber. As air accumulates in the chamber liquid is displaced downwardly until it reaches the lower end of the pipe 54. This is shown in FIG. 5 which illustrates the normal pressurised operating state of the valve. The pressure in the chamber 12 drives a column of liquid up the pipe 54 to buoy up the float 66 in the bleed valve chamber 56. As illustrated in FIG. 5, the float 66 seats on the lower end of the bleed tube 64 and seals it.

Accumulated air 70 cannot escape from the chamber 12 until there is a sufficient volume, at the operating pressure, to displace the liquid to a level beneath the lower end of the pipe 54, which serves as an entrance to the bleed valve chamber 66. As shown in FIG. 6, air can now vent upwardly from the chamber 12 into the bleed valve chamber through the pipe 54. With an accumulation of air in the bleed valve chamber the float 66 loses buoyancy and drops away from the lower end of the bleed tube 64, allowing air to vent to atmosphere as shown by the arrow.

Once a volume of air has been vented from the chamber 12 in this way and the liquid level rises again in the chamber 12, the chamber is repressurised and the process repeats itself.

It will be understood that a considerable volume 70 of air, defined by the level of the lower end of the pipe 54, can accumulate in the valve chamber 12 before pressurised venting takes place. As pointed out subsequently, this is considered to be an important advantage of the invention.

Sub-Atmospheric Conditions I Pipeline Emptying

Should sub-atmospheric conditions develop in the pipeline, for instance as a result of rapid closure of an upstream valve, the valve chamber 12 will rapidly empty of water and the sudden drop in pressure will cause the float 42 and dynamic closure 46 to drop back to the position seen in FIGS. 1 and 3. This allows atmospheric air to rush into the pipeline via the outlet 26 and valve chamber in order to equalise the pressure. Similarly, if the pipeline should be emptied of liquid, for instance as a result of a catastrophic event such as a pressure burst or a planned event such as a shut-down for maintenance, the same sequence of events will take place to admit atmospheric air.

It will accordingly be understood that apart from its function as an air release valve, the valve 10 also serves a vacuum breaking function.

The ability of the valve 10 to accumulate a substantial volume of pressurised air 70 in the chamber 12, attributable to the fact that the entrance to the pipe 54 is substantially below the buoyancy level of the float 42 is, as indicated above, considered to be an important advantage. The accumulated volume 70 of trapped air can act as an air cushion, “air spring” or shock absorber to damp pressure spikes which might occur in the pipeline during normal pressurised operation, thereby serving the function of conventional accumulator-type pressure dampers and possibly avoiding the need for separate pressure damping.

A secondary advantage is the adjustability of the pipe 54. In FIG. 1, the pipe is sealed with respect to the lid 24 by a gland 72. Depending on the amount of pressure damping required the pipe can be moved further into or out of the chamber to vary the elevation of the lower end of the pipe and hence the volume of pressurised air which can accumulate in the chamber before venting takes place.

In an alternative arrangement, not shown, the exterior of the pipe could be threaded and pass through a complementally threaded hole in the lid 24. With this arrangement, the pipe could be screwed into or out of the valve chamber to provide for variation of the pressure damping characteristics to suit the particular requirements of the installation.

Although specific mention is made above to “air” and an “air release valve” it will be appreciated that the valve 10 can be used to vent other gases from a liquid pipeline. Also, although the described embodiment has a single air vent passage 48 in the dynamic closure 46, it is possible for there to be a plurality of such passages which in combination have a smaller cross-section than the first outlet 26.

Also, although specific mention has been made of the function of the valve 10 to vent air from a liquid pipeline, it will be understood that it could equally well be used to vent air, in exactly the same way, from other liquid containers, for example an accumulator which is itself connected to a liquid pipeline.

As indicated previously the dynamic closure 46 is lifted up to seat against the O-ring 40 if the rate of air venting from the pipeline during pipeline filling exceeds a certain level at which the pressure differential acting on the dynamic closure creates a sufficient uplift force. In practice if pipeline filling takes place such that the rate at which air is vented is at an acceptable level for avoidance of shock loads, the dynamic closure will not be lifted up and will merely remain at a low position resting on the float 42. In this situation it is only when liquid in the chamber 12 reaches a level to buoy up the float and dynamic closure resting thereon that the dynamic closure is lifted up to seat on the O-ring 40.

1. An air release valve comprising a valve chamber having an inlet connectable to a liquid pipeline or container, a first outlet for venting relatively large volumes of air from the pipeline or container during filling of the pipeline or container with liquid, a second outlet for venting from the chamber relatively small volumes of air which accumulate in the chamber during pressurised operation of the pipeline or container, means for closing the first outlet when liquid rises in the chamber above a predetermined level, and a conduit which extends to the second outlet from an entrance located in the chamber substantially below the predetermined level, such that a volume of air can accumulate in the chamber to serve as a shock absorber for the pipeline or container before there is a sufficient accumulation of air to displace liquid from the chamber to a level beneath the entrance, whereupon venting of accumulated air can take place through the conduit and second outlet.

2. An air release valve according to claim 1 wherein the level of the entrance in the chamber is adjustable.

3. An air release valve according to claim 2 wherein the conduit is provided by a pipe extending downwardly into the chamber from the second outlet, the lower end of the pipe serving as the entrance.

4. An air release valve according to claim 3 wherein the pipe is externally threaded and passes in threaded fashion through a top of the chamber, whereby the pipe can be screwed further into or out of the chamber.

5. An air release valve according to any one of the preceding claims wherein the second outlet comprises an outlet chamber at an upper end of the pipe, an outlet nozzle from the outlet chamber and a float in the outlet chamber controlling the outlet nozzle.

6. An air release valve according to any one of the preceding claims comprising:
a dynamic closure arranged to seat on the first outlet when sufficiently rapid venting of air takes place from the pipeline or container during filling thereof,
a passage extending through the dynamic closure which communicates with but is smaller than the first outlet and through which air can vent at a reduced rate, and
a main closure adapted to be buoyed up by liquid in the chamber, when the liquid rises above the predetermined level, to seat on the dynamic closure and close the passage therein, thereby to close the first outlet completely.
